(19) United States
(12) Patent Application Publication
(10) Pub. No.: US 2008/0254361 A1
(43) Pub. Date: Oct. 16, 2008

(54) Non-Aqueous Electrolyte for Battery and Non-Aqueous Electrolyte Secondary Battery Comprising the Same

(75) Inventor: Yasuo Horikawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Chuo-ku, Tokyo (JP)

(21) Appl. No.: 11/910,022

(22) PCT Filed: Mar. 20, 2006
(86) PCT No.: PCT/JP2006/305541

§ 371 Date: Sep. 28, 2007

(30) Foreign Application Priority Data
Mar. 31, 2005 (JP) 2005-102046
Apr. 5, 2005 (JP) 2005-108691

(51) Int. Cl. H01M 6/04

(52) U.S. Cl. 429/188

(57) ABSTRACT

This invention relates to a non-aqueous electrolyte for a battery capable of simultaneously establishing a high flame retardance and excellent battery performances, and more particularly to a non-aqueous electrolyte for a battery comprising a non-aqueous solvent and a support salt, characterized in that the non-aqueous electrolyte for the battery further contains a fluorophosphate compound represented by the following general formula (I):

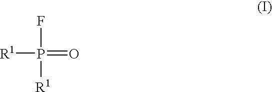

[wherein R¹s are independently fluorine, an alkoxy group or an aryloxy group and at least one of two R¹s is the alkoxy group or the aryloxy group, provided that two R¹s may be bonded with each other to form a ring].

### TECHNICAL FIELD

This invention relates to a non-aqueous electrolyte for a battery and a non-aqueous electrolyte secondary battery comprising the same, and more particularly to a non-aqueous electrolyte for a battery having high flame retardance and resistance to reduction and a non-aqueous electrolyte for a battery having high electric conductivity and flame retardance as well as a non-aqueous electrolyte secondary battery having excellent safety and cyclability and a non-aqueous electrolyte secondary battery having excellent safety and load characteristics.

### BACKGROUND ART

The non-aqueous electrolyte is used as an electrolyte for a lithium battery, a lithium ion secondary battery, an electric double layer capacitor or the like. These devices have a high voltage and a high energy density, so that they are widely used as a driving power source for personal computers, mobile phones and the like. As the non-aqueous electrolyte are generally used ones obtained by dissolving a support salt such as LiPF₆ or the like in an aprotic organic solvent such as an ester compound, an ether compound or the like. However, since the aprotic organic solvent is combustible, if it leaks from the device, there is a possibility of firing-burning and also there is a problem in view of the safety.

Also, a lithium ion battery using a carbonaceous material such as graphite or the like as a negative electrode and a lithium-transition metal composite oxide such as LiCoO₂ or the like as a positive electrode is currently and widely used as a secondary battery having a high voltage and a high energy density and as a driving power source for note-type personal computers, mobile phones and the like, but a lithium secondary battery using as an active material for a negative electrode lithium or lithium alloy having a higher theoretical energy density per unit weight or unit volume as compared with the above-described carbon-based material for the negative electrode is expected to be put into practical use as a secondary battery having a further higher energy density in the future. However, when lithium or lithium alloy is used as an active material for a negative electrode, there is a problem of a dendrite wherein uneven electrodeposition and dissolution of a lithium metal are caused by repetition of discharge-recharge to grow lithium in a dendritic form. The resulting dendrite not only brings about the lowering of the battery performances but also may pass through a separator disposed between the positive and negative electrodes to cause short-circuiting of the battery. As an electrolyte for the lithium secondary battery are generally used combustible organic solvents such as an ester compound, an ether compound and the like as mentioned above and heat generation and ignition may be caused in the worst case, so that a higher safety than that of the above-mentioned lithium ion battery is required for the practical application of the lithium secondary battery.

On the contrary, there is examined a method for rendering the non-aqueous electrolyte into a flame retardance. For example, there are proposed a method wherein a phosphate such as trimethyl phosphate or the like is used in the non-aqueous electrolyte, and a method wherein the phosphate is added to the aprotic organic solvent (see JP-A-H04-184870, JP-A-H08-22839 and JP-A-2000-182669). However, these phosphates are gradually reduction-decomposed on the negative electrode by repetition of discharge and recharge, so that there is a problem that battery performances such as discharge-recharge efficiency, cyclability and the like are largely deteriorated. Also, usual phosphate triesters are not necessarily high in the flame retardance, so that it is necessary to increase the amount thereof in order to sufficiently develop a flame retardant effect. However, the electric conductivity of the electrolyte is lowered as the amount of the phosphate triester compounded in the electrolyte is increased and also the phosphate triester is not an electrochemically stable material, so that it is gradually reduction-decomposed on the negative electrode by repetition of discharge and recharge and hence there is a problem that the battery performances such as discharge and recharge efficiency and the like are largely deteriorated.

As to this problem, there are attempted a method wherein a compound for suppressing the decomposition of the phosphate is further added to the non-aqueous electrolyte, a method wherein the molecular structure of the phosphate itself is devised, and so on (see JP-A-H11-67267, JP-A-H10-189040, JP-A-2003-109659 and JP-A-H11-260401). In these methods, however, as the amount of the phosphate added is increased, the effect of suppressing the decomposition becomes insufficient, so that there is a limit in the addition amount of the phosphate as it stands now. Also, since the phosphate triester has a high viscosity and a low electric conductivity, even if the amount thereof is small, the lowering of the electric conductivity is caused and the degradation of the discharge and recharge efficiency is caused under a high load condition or a low temperature condition. Particularly, in the discharge and recharge at a high current density (high rate) as a high load condition, the reductive decomposition of the phosphate triester easily proceeds and the cyclability of the battery is considerably deteriorated even if the amount is small.

As mentioned above, the conventional techniques using the phosphate triester is not necessarily sufficient in a point of ensuring the safety of the electrolyte and the battery performances, so that it is necessary to make a basic study on the structure of the phosphate itself.

### DISCLOSURE OF THE INVENTION

It is, therefore, an object of the invention to solve the above-mentioned problems of the conventional techniques and to provide a non-aqueous electrolyte for a battery capable of simultaneously establishing the high flame retardance and excellent battery performances and a non-aqueous electrolyte secondary battery comprising the non-aqueous electrolyte.

The inventor has made various studies in order to achieve the above object and succeeded in discovering a phosphate compound having a structure capable of solving the drawbacks of the conventional phosphates, and as a result the invention has been accomplished.

That is, the non-aqueous electrolyte for the battery according to the invention is a non-aqueous electrolyte for a battery comprising a non-aqueous solvent and a support salt, and is characterized in that the non-aqueous electrolyte for the battery further contains a fluorophosphate compound represented by the following general formula (I):

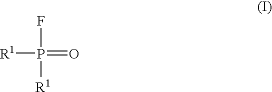

[wherein R¹s are independently fluorine, an alkoxy group or an aryloxy group and at least one of two R¹s is the alkoxy group or the aryloxy group, provided that two R¹s may be bonded with each other to form a ring].

In a preferable embodiment of the non-aqueous electrolyte for the battery according to the invention, one of two R¹s is fluorine and the other is the alkoxy group or the aryloxy group in the general formula (I).

In another preferable embodiment of the non-aqueous electrolyte for the battery according to the invention, at least one of two R¹s in the general formula (I) is a fluorine atom-substituted alkoxy group or a fluorine atom-substituted aryloxy group. In this case, the non-aqueous electrolyte for the battery has a low viscosity and is excellent in the safety. Moreover, it is more preferable that one of two R¹s is fluorine and the other is the fluorine atom-substituted alkoxy group or the fluorine atom-substituted aryloxy group in the general formula (I). In this case, the non-aqueous electrolyte for the battery is particularly low in the viscosity and excellent in the safety.

The non-aqueous electrolyte for the battery according to the invention is preferable to further contain an unsaturated cyclic ester compound represented by the following general formula (II):

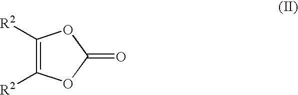

[wherein R²s are independently hydrogen, fluorine or an alkyl group having a carbon number of 1-2]. In this case, the load characteristics of the non-aqueous electrolyte secondary battery can be further improved. Moreover, a content of the unsaturated cyclic ester compound represented by the general formula (II) is more preferable to be 0.1-10% by mass based on the whole of the non-aqueous electrolyte.

In the other preferable embodiment of the non-aqueous electrolyte for the battery according to the invention, the non-aqueous solvent comprises an aprotic organic solvent.

In the non-aqueous electrolyte for the battery according to the invention, a content of the fluorophosphate compound represented by the general formula (I) is preferably not less than 5% by volume, more preferably not less than 10% by volume, most preferably not less than 20% by volume based on the whole of the non-aqueous electrolyte for the battery.

Also, the non-aqueous electrolyte secondary battery according to the invention comprises the above-described non-aqueous electrolyte for the battery, a positive electrode and a negative electrode. Moreover, it is preferable that lithium or an alloy thereof is used in the negative electrode. In this case, a secondary battery having a higher energy than conventional ones can be put into practical use.

According to the invention, there can be obtained an electrolyte being excellent in the electric conductivity and electrochemical stability and developing the high flame retardance by using a fluorophosphate compound of the formula (I) in the electrolyte, even if the amount thereof is increased (particularly, even if the amount of the fluorophosphate compound of the formula (I) compounded is not less than 20% by volume). Thus, there can be provided a non-aqueous electrolyte secondary battery (particularly lithium secondary battery) being excellent in the load characteristics and considerably suppressing the risks of burst, igniting and firing or highly improving the safety. Although the reason is not necessarily clear, it is considered that the fluorophosphate compound of the formula (I) has a molecular size smaller than that of the usual phosphate triester, and the effect of reducing an intermolecular force through a phosphorus-fluorine bond contributes to decrease a viscosity, and further the specific molecular structure enhances a dissociation of a lithium ion and improves the electric conductivity of the electrolyte. Moreover, it is considered that the phosphorus-fluorine bond possessed by the fluorophosphate compound of the formula (I) improves a resistance to reduction of the whole of phosphate molecule and generates a gas component effective for being non-combustible in the thermal decomposition and develops the high flame retardance.

Also, when at least one of two R¹s in the formula (I) is a fluorine atom-substituted alkoxy group or a fluorine atom-substituted aryloxy group, there can be obtained an electrolyte being excellent in the electric conductivity and resistance to reduction and developing the high flame retardance by using the fluorophosphate compound represented by the formula (I) in the non-aqueous electrolyte for the battery even if the addition amount is small. Thus, there can be provided a non-aqueous electrolyte secondary battery being excellent in the cyclability under the high load condition and considerably suppressing the risks of burst, igniting and firing or highly improving the safety. Although the reason is not necessarily clear, it is considered that since the compound of the formula (I) is a fluorophosphate compound having a phosphorus-fluorine bond and has a smaller molecular size and a lower viscosity than those of the usual phosphate triester, the degradation of the electric conductivity of the non-aqueous electrolyte can be suppressed. Further, when at least one of two R¹s in the formula (I) is the fluorine atom-substituted alkoxy group or fluorine atom-substituted aryloxy group, it is considered that the specific structure of the compound of the formula (I) having the phosphorus-fluorine bond and the fluorine atom-substituted group enhances the resistance to reduction of the non-aqueous electrolyte or forms a stable film having an effect of suppressing the reductive decomposition on a surface of an electrode. Also, it is considered that the high flame retardant effect also results from the generation of a more non-combustible gas component in the thermal decomposition by a synergetic effect of a carbon-fluorine bond and a phosphorus-fluorine bond included in the compound of the formula (I).

### BEST MODE FOR CARRYING OUT THE INVENTION

<Non-Aqueous Electrolyte for Battery>

The non-aqueous electrolyte for the battery according to the invention will be described in detail below. The non-aqueous electrolyte for the battery according to the invention comprises the non-aqueous solvent containing the fluorophosphate compound represented by the formula (I), and the support salt and may further contain an aprotic organic solvent as the non-aqueous solvent.

The fluorophosphate compound included in the non-aqueous electrolyte for the battery according to the invention is represented by the formula (I). In the formula (I), R¹s are independently fluorine, an alkoxy group or an aryloxy group and at least one of two R¹s is the alkoxy group or the aryloxy group.

As the alkoxy group in R¹ of the formula (I) are mentioned methoxy group, ethoxy group, propoxy group, butoxy group, allyloxy group having a double bond, and alkoxy-substituted alkoxy groups such as methoxy ethoxy group, methoxy ethoxy ethoxy group and the like. In these alkoxy groups, a hydrogen element may be substituted with a halogen element and is preferable to be substituted with fluorine. Among them, methoxy group, ethoxy group, trifluoroethoxy group and propoxy group are preferable from a viewpoint of an excellent flame retardance and a low viscosity.

As the aryloxy group in R¹ of the formula (I) are mentioned phenoxy group, methylphenoxy group, methoxy phenoxy group and the like. In these aryloxy groups, a hydrogen element may be substituted with a halogen element and is preferable to be substituted with fluorine. Among them, phenoxy group and fluorophenoxy group are preferable from a viewpoint of an excellent flame retardance.

Two R¹s in the general formula (I) may be same or different. Also, two R¹s may be linked. In the latter case, two R¹s are bonded with each other to form an alkylenedioxy group, an arylenedioxy group or an oxyalkylene-aryleneoxy group, and as such a bivalent group are mentioned ethylenedioxy group, propylenedioxy group and the like. Among the fluorophosphate compounds of the general formula (I), a difluorophosphate wherein one of two R¹s is fluorine and the other is the alkoxy group or the aryloxy group is most preferable from a viewpoint of a low viscosity and a flame retardance.

As the fluorophosphate compound of the general formula (I) are concretely mentioned dimethyl fluorophosphate, diethyl fluorophosphate, bistrifluoroethyl fluorophosphate, ethylene fluorophosphate, propylene fluorophosphate, dipropyl fluorophosphate, dibutyl fluorophosphate, diphenyl fluorophosphate, difluorophenyl fluorophosphate, methyl difluorophosphate, ethyl difluorophosphate, trifluoroethyl difluorophosphate, propyl difluorophosphate, butyl difluorophosphate, cyclohexyl difluorophosphate, methoxyethyl difluorophosphate, methoxyethoxyethyl difluorophosphate, phenyl difluorophosphate, fluorophenyl difluorophosphate and the like. Among them, methyl difluorophosphate, ethyl difluorophosphate, trifluoroethyl difluorophosphate, propyl difluorophosphate and phenyl difluorophosphate are more preferable. These fluorophosphate compounds of the formula (I) may be used alone or in a combination of two or more.

In the general formula (I), at least one of two R¹s is preferable to be a fluorine atom-substituted alkoxy group or a fluorine atom-substituted aryloxy group. In this case, the non-aqueous electrolyte for the battery has a low viscosity and is excellent in the safety.

As the fluorine atom-substituted alkoxy group in R¹ of the formula (I) are mentioned 2-fluoroethoxy group, 2,2-difluoroethoxy group, 2,2,2-trifluoroethoxy group, 2,2,2-trifluoropropoxy group, 2,2,3,3-tetrafluoropropoxy group, 2,2,3,3,3-pentafluoropropoxy group, 2-fluoroisopropoxy group, 2,2-difluoroisopropoxy group, 2,2,2-trifluoroisopropoxy group, tetrafluoroisopropoxy group, pentafluoroisopropoxy group, hexafluoroisopropoxy group, heptafluorobutoxy group, hexafluorobutoxy group, octafluorobutoxy group, perfluoro-t-butoxy group, hexafluoroisobutoxy group, octafluoropentyloxy group and the like.

As the fluorine atom-substituted aryloxy group in R¹ of the formula (I) are mentioned 2-fluorophenoxy group, 3-fluorophenoxy group, 4-fluorophenoxy group, 2,4-difluorophenoxy group, 2-fluoro-4-methylphenoxy group, trifluorophenoxy group, tetrafluorophenoxy group, pentafluorophenoxy group, 2-fluoromethylphenoxy group, 4-fluoromethylphenoxy group, 2-difluoromethylphenoxy group, 3-difluoromethylphenoxy group, 4-difluoromethylphenoxy group, 2-trifluoromethylphenoxy group, 3-trifluoromethylphenoxy group, 4-trifluoromethylphenoxy group, 2-fluoro-4-methoxylphenoxy group and the like.

When at least one of two R¹s in the general formula (I) is the fluorine atom-substituted alkoxy group or the fluorine atom-substituted aryloxy group and two R¹s are linked, these two R¹s are bonded with each other to form a fluorine atom-substituted alkylenedioxy group, a fluorine atom-substituted arylenedioxy group or a fluorine atom-substituted oxyalkylene-aryleneoxy group, and as such a bivalent group are mentioned fluoroethylenedioxy group, difluoroethylenedioxy group, fluoropropylenedioxy group, difluoropropylenedioxy group, trifluoropropylenedioxy group and the like. Among the fluorophosphate compounds of the general formula (I), a difluorophosphate wherein one of two R¹s is fluorine and the other is the fluorine atom-substituted alkoxy group or the fluorine atom-substituted aryloxy group is most preferable from a viewpoint of the low viscosity and the flame retardance.

As the fluorophosphate compound of the formula (I) wherein at least one of two R¹s is the fluorine atom-substituted alkoxy group or the fluorine atom-substituted aryloxy group are concretely mentioned methyl (trifluoroethyl) fluorophosphate, ethyl (trifluoroethyl) fluorophosphate, propyl (trifluoroethyl) fluorophosphate, allyl (trifluoroethyl) fluorophosphate, butyl (trifluoroethyl) fluorophosphate, phenyl (trifluoroethyl) fluorophosphate, bis(trifluoroethyl) fluorophosphate, methyl (tetrafluoropropyl) fluorophosphate, ethyl (tetrafluoropropyl) fluorophosphate, tetrafluoropropyl (trifluoroethyl) fluorophosphate, phenyl (tetrafluoropropyl) fluorophosphate, bis(tetrafluoropropyl) fluorophosphate, methyl (fluorophenyl) fluorophosphate, ethyl (fluorophenyl) fluorophosphate, fluorophenyl (trifluoroethyl) fluorophosphate, difluorophenyl fluorophosphate, fluorophenyl (tetrafluoropropyl) fluorophosphate, methyl (difluorophenyl) fluorophosphate, ethyl (difluorophenyl) fluorophosphate, difluorophenyl (trifluoroethyl) fluorophosphate, bis(difluorophenyl) fluorophosphate, difluorophenyl (tetrafluoropropyl) fluorophosphate, fluoroethylene fluorophosphate, difluoroethylene fluorophosphate, fluoropropylene fluorophosphate, difluoropropylene fluorophosphate, trifluoropropylene fluorophosphate, fluoroethyl difluorophosphate, difluoroethyl difluorophosphate, fluoropropyl difluorophosphate, difluoropropyl difluorophosphate, trifluoropropyl difluorophosphate, tetrafluoropropyl difluorophosphate, pentafluoropropyl difluorophosphate, fluoroisopropyl difluorophosphate, difluoroisopropyl difluorophosphate, trifluoroisopropyl difluorophosphate, tetrafluoroisopropyl difluorophosphate, pentafluoroisopropyl difluorophosphate, hexafluoroisopropyl difluorophosphate, heptafluorobutyl difluorophosphate, hexafluorobutyl difluorophosphate, octafluorobutyl difluorophosphate, perfluoro-t-butyl difluorophosphate, hexafluoroisobutyl difluorophosphate, fluorophenyl difluorophosphate, difluorophenyl difluorophosphate, 2-fluoro-4-methylphenyl difluorophosphate, trifluorophenyl difluorophosphate, tetrafluorophenyl difluorophosphate, pentafluorophenyl difluorophosphate, 2-fluoromethylphenyl difluorophosphate, 4-fluoromethylphenyl difluorophosphate, 2-difluoromethylphenyl difluorophosphate, 3-difluoromethylphenyl difluorophosphate, 4-difluoromethylphenyl difluorophosphate, 2-trifluoromethylphenyl difluorophosphate, 3-trifluoromethylphenyl difluorophosphate, 4-trifluoromethylphenyl difluorophosphate, 2-fluoro-4-methoxylphenyl difluorophosphate and the like. Among them, fluoroethylene fluorophosphate, bis(trifluoroethyl) fluorophosphate, fluoroethyl difluorophosphate, trifluoroethyl difluorophosphate, propyl difluorophosphate and phenyl difluorophosphate are preferable, and fluoroethyl difluorophosphate, tetrafluoropropyl difluorophosphate and fluorophenyl difluorophosphate are more preferable in view of the low viscosity and flame retardance. These fluorophosphate compounds may be used alone or in a combination of two or more.

The content of the fluorophosphate compound of the formula (I) is preferably not less than 5% by volume, more preferably not less than 10% by volume, most preferably not less than 20% by volume based on the whole of the non-aqueous electrolyte for the battery. When the content of the fluorophosphate compound of the formula (I) is not less than 5% by volume, the non-aqueous electrolyte has a tendency capable of developing the flame retardance. When it is not less than 10% by volume, the non-aqueous electrolyte has a tendency capable of developing the non-combustibility. When it is not less than 20% by volume, the non-aqueous electrolyte expresses the non-combustibility and considerably develops the effect of improving the load characteristics.

In the non-aqueous electrolyte for the battery according to the invention, it is preferable to use the unsaturated cyclic ester compound represented by the general formula (II) together with the fluorophosphate compound of the formula (I). In this case, the more excellent load characteristics can be obtained. Although the reason is not necessarily clear, it is considered that a protective film having a higher lithium ion conductivity is formed on a surface of an electrode by using the fluorophosphate compound of the formula (I) and the unsaturated cyclic ester compound of the formula (II). In the formula (II), R²s are independently hydrogen, fluorine or an alkyl group having a carbon number of 1-2, and a hydrogen element in the alkyl group may be substituted with fluorine.

As the unsaturated cyclic ester compound of the formula (II) are concretely mentioned vinylene carbonate, catechol carbonate, 4-fluorovinylene carbonate, 4,5-difluorovinylene carbonate, 4-methylvinylene carbonate, 4,5-dimethylvinylene carbonate, 4-fluoromethylvinylene carbonate, 4-difluoromethylvinylene carbonate, 4-trifluoromethylvinylene carbonate, 4-ethylvinylene carbonate, 4,5-diethylvinylene carbonate, 4-fluoroethylvinylene carbonate, 4-difluoroethylvinylene carbonate, 4-trifluoroethylvinylene carbonate, 4,5-bistrifluoromethylvinylene carbonate and the like. Among them, vinylene carbonate and 4-fluorovinylene carbonate are preferable. These unsaturated cyclic ester compounds may be used alone or in a combination of two or more.

The content of the unsaturated cyclic ester compound is preferably within a range of 0.1-10% by mass, more preferably within a range of 0.5-8% by mass based on the whole of the non-aqueous electrolyte from a viewpoint of balancing the battery performances.

Also, the non-aqueous electrolyte may be added with an aprotic organic solvent within a scope of not damaging the object of the invention. Since the fluorophosphate compound of the formula (I) has the high flame retardance, when the amount of the aprotic organic solvent added is not more than 95% by volume, the non-aqueous electrolyte can develop the flame retardance, but the amount of the aprotic organic solvent added is more preferable to be not more than 90% by volume in order that the non-aqueous electrolyte provides the non-combustibility. As the aprotic organic solvent are concretely mentioned carbonates such as dimethyl carbonate (DMC), diethyl carbonate (DEC), diphenyl carbonate, ethyl methyl carbonate (EMC), ethylene carbonate (EC), propylene carbonate (PC), vinylene carbonate (VC) and so on; ethers such as 1,2-dimethoxy ethane (DME), tetrahydrofuran (THF), diethyl ether (DEE), phenyl methyl ether and so on; γ-butyrolactone (GBL), γ-valerolactone, carboxylate esters such as methyl formate (MF) and so on; nitriles such as acetonitrile and so on; amides such as dimethylformamide and so on; and sulfones such as dimethyl sulfoxide and so on. These aprotic organic solvents may include an unsaturated bond and a halogen element. Among these aprotic organic solvents, ethylene carbonate (EC), vinylene carbonate (VC) and propylene carbonate (PC) are preferable. Moreover, these aprotic organic solvents may be used alone or in a combination of two or more.

Moreover, to the non-aqueous electrolyte for the battery according to the invention may be added unsaturated heterocyclic compounds such as thiophene and furan, aromatic hydrocarbons such as naphthalene and biphenyl derivatives and the like, which are assumed to have an effect of suppressing the growth of dendrite or the like, within a scope of not damaging the object of the invention. Also, the non-aqueous electrolyte for the battery according to the invention may be added with a phosphazene compound having a P═N bond, or the like.

The non-aqueous electrolyte according to the invention can be used as it is, but may be used, for example, by impregnating and keeping into a suitable polymer, a porous support or a gelatinous material.

As the support salt used in the non-aqueous electrolyte for the battery of the invention is preferable a support salt serving as an ion source for a lithium ion. The support salt is not particularly limited, but preferably includes lithium salts such as LiClO₄, LiBF₄, LiPF₆, LiCF₃SO₃, LiAsF₆, LiC₄F₉SO₃, Li(CF₃SO₂)₂N, Li(C₂F₅SO₂)₂N and so on. Among them, LiPF₆ is more preferable in a point that the non-combustibility is excellent. These support salts may be used alone or in a combination of two or more.

The concentration of the support salt in the non-aqueous electrolyte is preferably 0.2-1.5 mol/L (M), more preferably 0.5-1 mol/L (M). When the concentration of the support salt is less than 0.2 mol/L, the electric conductivity of the electrolyte cannot be sufficiently ensured and troubles may be caused in the discharge property and the charge property of the battery, while when it exceeds 1.5 mol/L, the viscosity of the electrolyte rises and the sufficient mobility of the lithium ion cannot be ensured, and hence the sufficient electric conductivity of the electrolyte cannot be ensured and troubles may be caused in the discharge property and the charge property of the battery likewise the above-mentioned case.

<Non-Aqueous Electrolyte Secondary Battery>

Then, the non-aqueous electrolyte secondary battery according to the invention will be described in detail. The non-aqueous electrolyte secondary battery of the invention comprises the above-mentioned non-aqueous electrolyte, a positive electrode and a negative electrode, and may be provided with other members usually used in the technical field of the non-aqueous electrolyte secondary battery such as a separator and the like, if necessary.

As an active material for the positive electrode of the non-aqueous electrolyte secondary battery according to the invention are preferably mentioned metal oxides such as V₂O₅, V₆O₁₃, MnO₂, MnO₃ and the like; lithium-containing composite oxides such as LiCoO₂, LiNiO₂, LiMn₂O₄, LiFeO₂, LiFePO₄ and the like; metal sulfides such as TiS₂, MoS₂ and the like; and electrically conductive polymers such as polyaniline and the like. The lithium-containing composite oxide may be a composite oxide including two or three transition metals selected from the group consisting of Fe, Mn, Co and Ni. In this case, the composite oxide is represented by LiFeₓCo_{y}Ni_{(1-x-y)}O₂ [wherein 0≦x≦1, 0≦y≦1, 0<x+y≦1], LiMnₓFe_{y}O_{2-x-y} or the like. Among them, LiCoO₂, LiNiO₂ and LiMn₂O₄ are particularly preferable because they have a high capacity and are high in the safety and excellent in the wettability to the electrolyte. These active materials for the positive electrode may be used alone or in a combination of two or more.

As an active material for the negative electrode of the non-aqueous electrolyte secondary battery according to the invention are preferably mentioned lithium metal itself; an alloy of lithium with Al, In, Sn, Si, Pb, Zn or the like; a carbonaceous material such as graphite doped with lithium, and the like. Among them, the carbonaceous material such as graphite or the like is preferable and graphite is particularly preferable in a point that the safety is higher and the wettablility to the electrolyte is excellent. As the graphite are mentioned natural graphite, artificial graphite, mesophase carbon micro bead (MCMB) and so on, and may further be mentioned graphitizable carbon and hardly-graphitizable carbon. These active materials for the negative electrode may be used alone or in a combination of two or more. Moreover, when lithium or lithium alloy having a higher theoretical energy density per unit weight or unit volume as compared with the carbon-based material for the negative electrode is used in the negative electrode, there can be obtained a non-aqueous electrolyte secondary battery (lithium secondary battery) having a high energy.

The positive electrode and the negative electrode may be mixed with an electrically conducting agent and a binding agent, if necessary. As the electrically conducting agent are mentioned acetylene black and the like, and as the binding agent are mentioned polyvinylidene fluoride (PVDF), polytetrafluoroethylene (PTFE), styrene-butadiene rubber (SBR), carboxymethyl cellulose (CMC) and the like. These additives may be used in the same compounding ratio as in the conventional case.

As the other member used in the non-aqueous electrolyte secondary battery of the invention is mentioned a separator interposed between the positive and negative electrodes in the non-aqueous electrolyte secondary battery so as to prevent short-circuiting of current due to the contact between the electrodes. As a material of the separator are preferably mentioned materials capable of surely preventing the contact between the electrodes and passing or impregnating the electrolyte such as non-woven fabrics, thin-layer films and the like made of a synthetic resin such as polytetrafluoroethylene, polypropylene, polyethylene, cellulose based resin, polybutylene terephthalate, polyethylene terephthalate or the like. They may be a single substance, a mixture or a copolymer. Among them, a microporous film having a thickness of about 20-50 μm and made of polypropylene or polyethylene, and a film made of cellulose based resin, polybutylene terephthalate, polyethylene terephthalate or the like are particularly preferable. In the invention, various well-known members usually used in the battery can be preferably used in addition to the above separator.

The form of the above-described non-aqueous electrolyte secondary battery according to the invention is not particularly limited, but there are preferably mentioned various well-known forms such as coin type, button type, paper type, cylindrical type of polygonal form or spiral structure and so on. In case of the button type, the non-aqueous electrolyte secondary battery can be made by preparing sheet-shaped positive and negative electrodes and sandwiching the separator between the positive and negative electrodes. Also, in case of the spiral structure, the non-aqueous electrolyte secondary battery can be made by preparing a sheet-shaped positive electrode, sandwiching between collectors, piling a sheet-shaped negative electrode thereon and then winding them or the like.

### EXAMPLES

The following examples are given in illustration of the invention and are not intended as limitations thereof.

### Example 1

A non-aqueous electrolyte is prepared by dissolving LiPF₆ at a concentration of 1 mol/L in a mixed solvent comprising 10% by volume of fluorophenyl difluorophosphate, 45% by volume of ethylene carbonate and 45% by volume of methyl ethyl carbonate, and the flame retardance of the non-aqueous electrolyte is evaluated by the following method (1). A result is shown in Table 1.

(1) Evaluation of Flame Retardance

A burning length and a burning time of a flame ignited under an atmospheric environment are measured and evaluated according to a method arranging UL94HB method of UL (Underwriting Laboratory) standard. Concretely, a test piece is prepared by impregnating a SiO₂ sheet of 127 mm×12.7 mm with 1.0 mL of the electrolyte based on UL test standard and evaluated. Evaluation standards of non-combustibility, flame retardance, self-extinguishing property and combustion property are shown below.

<Evaluation of non-combustibility> In a case that a test flame does not ignite a test piece (combustion length: 0 mm), it is evaluated that there is non-combustibility.
<Evaluation of flame retardance> In a case that the ignited flame does not arrive at a line of 25 mm and the ignition is not observed in the falling object, it is evaluated that there is flame retardance.
<Evaluation of self-extinguishing property> In a case that the ignited flame extinguishes at a line of 25-100 mm and the ignition is not observed in a falling object, it is evaluated that there is self-extinguishing property.
<Evaluation of combustion property> In a case that the ignited flame exceeds a line of 100 mm, it is evaluated that there is combustion property.

Then, lithium-cobalt composite oxide [LiCoO₂] is used as an active material for a positive electrode, and this oxide, acetylene black as an electrically conducting agent and polyvinylidene fluoride as a binding agent are mixed at a mass ratio of 94:3:3 and dispersed into N-methylpyrrolidone to prepare a slurry, and the slurry is applied on an aluminum foil as a collector for a positive electrode, dried and then punched out in the form of a disk having a diameter of 12.5 mm to make a positive electrode. Also, an artificial graphite is used as an active material for a negative electrode, and the artificial graphite and polyvinylidene fluoride as a binding agent are mixed at a mass ratio of 90:10 and dispersed into an organic solvent (mixed solvent of 50/50% by mass of ethyl acetate and ethanol) to prepare a slurry, and the slurry is applied on a copper foil as a collector for a negative electrode, dried and then punched out in the form of a disk having a diameter of 12.5 mm to make a negative electrode. Then, the positive and negative electrodes are overlapped through a separator (micro-porous film: made of polypropylene) impregnated with the electrolyte, and accommodated in a stainless case serving as a positive terminal, and sealed with a stainless sealing plate serving as a negative terminal through a polypropylene gasket to prepare a coin-type battery (non-aqueous electrolyte secondary battery) having a diameter of 20 mm and a thickness of 1.6 mm. With respect to the resulting coin-type battery, a discharge-recharge test is also conducted according to the following method (2).

(2) Discharge-Recharge Test for the Coin-Type Battery (Initial Discharge Capacity and Capacity Remaining Ratio)

With respect to the thus obtained coin-type battery, discharge-recharge are repeated in an atmosphere of 20° C. at a voltage range of 4.2-3.0 V and a current density of 2 mA/cm² two cycles, and the discharge capacity measured at this time is divided by a known mass of the electrode to determine the initial discharge capacity (mAh/g). Furthermore, the discharge-recharge are repeated up to 50 cycles under the same discharge-recharge conditions to determine the discharge capacity after 50 cycles, and the capacity remaining ratio S is calculated according to the following equation:

Capacity remaining ratio S=discharge capacity after 50 cycles/initial discharge capacity×100(%)

and is used as an indication for the cyclability under the high load condition. Results are shown in Table 1.

### Example 2

A non-aqueous electrolyte is prepared in the same manner as in Example 1 except that 50% by volume of bis(trifluoroethyl) fluorophosphate, 25% by volume of ethylene carbonate and 25% by volume of methyl ethyl carbonate are used in “the preparation of the non-aqueous electrolyte” in Example 1, and the flame retardance of the resulting non-aqueous electrolyte is evaluated. Also, a non-aqueous electrolyte secondary battery is made in the same manner as in Example 1, and the initial discharge capacity and the cyclability of the battery in the discharge-recharge test are measured and evaluated, respectively. Results are shown in Table 1.

### Example 3

A non-aqueous electrolyte is prepared in the same manner as in Example 1 except that 100% by volume of tetrafluoropropyl difluorophosphate is used in “the preparation of the non-aqueous electrolyte” in Example 1, and the flame retardance of the resulting non-aqueous electrolyte is evaluated. Also, a non-aqueous electrolyte secondary battery is made in the same manner as in Example 1 except that the negative electrode is a lithium sheet, and the initial discharge capacity and the cyclability of the battery in the discharge-recharge test are measured and evaluated, respectively. Results are shown in Table 1.

### Comparative Example 1

A non-aqueous electrolyte is prepared in the same manner as in Example 1 except that 10% by volume of trimethyl phosphate, 45% by volume of ethylene carbonate and 45% by volume of ethyl methyl carbonate are used in “the preparation of the non-aqueous electrolyte” in Example 1, and the flame retardance of the resulting non-aqueous electrolyte is evaluated. Also, a non-aqueous electrolyte secondary battery is made in the same manner as in Example 1, and the initial discharge capacity and the cyclability of the battery in the discharge-recharge test are measured and evaluated, respectively. Results are shown in Table 1.

### Comparative Example 2

A non-aqueous electrolyte is prepared in the same manner as in Example 1 except that 50% by volume of tris(trifluoroethyl) phosphate, 25% by volume of ethylene carbonate and 25% by volume of ethyl methyl carbonate are used in “the preparation of the non-aqueous electrolyte” in Example 1, and the flame retardance of the resulting non-aqueous electrolyte is evaluated. Also, a non-aqueous electrolyte secondary battery is made in the same manner as in Example 1, and the initial discharge capacity and the cyclability of the battery in the discharge-recharge test are measured and evaluated, respectively. Results are shown in Table 1.

TABLE 1

| | | Initial | Capacity |
|---|---|---|---|
| | | discharge | remaining |
| | Evaluation of | capacity | ratio S |
| | flame retardance | (mAh/g) | (%) |
| Example 1 | Non-combustibility | 116 | 98 |
| Example 2 | Non-combustibility | 128 | 95 |
| Example 3 | Non-combustibility | 125 | 92 |
| Comparative | Self-extinguishing | 96 | 12 |
| Example 1 | property | | |
| Comparative | Non-combustibility | 48 | 8 |
| Example 2 | | | |

As shown in Examples 1-3 of Table 1, the non-aqueous electrolyte containing not less than 10% by volume of the compound of the general formula (I) has a non-combustibility and the secondary battery using the same has excellent initial discharge capacity and cyclability even under the high load condition, so that it is determined that the compound of the general formula (I) has an effect of improving the electric conductivity and resistance to reduction of the non-aqueous electrolyte. Thus, it is confirmed that the non-aqueous electrolyte according to the invention has the high flame retardance and resistance to reduction and the non-aqueous electrolyte secondary battery having excellent safety and cyclability can be obtained by using the non-aqueous electrolyte in the secondary battery.

On the other hand, as seen from Comparative Examples 1 and 2 in Table 1, the phosphate triesters deteriorate the electric conductivity of the non-aqueous electrolyte even if a fluorine atom-substituted alkoxy group is included in the substituent, and are not sufficient in the resistance to reduction, which considerably deteriorate the discharge capacity and cyclability of the secondary battery.

### Example 4

A non-aqueous electrolyte is prepared by dissolving LiPF₆ at a concentration of 1 mol/L in a mixed solvent comprising 20% by volume of methyl difluorophosphate, 40% by volume of ethylene carbonate and 40% by volume of methyl ethyl carbonate, and an electric conductivity at 25° C. thereof is measured by using an electric conductivity meter. Also, the evaluation of the flame retardance is carried out by the above method (1). Results are shown in Table 2.

Then, lithium-manganese composite oxide (LiMn₂O₄) is used as an active material for a positive electrode, and this oxide, acetylene black as an electrically conducting agent and fluorocarbon resin as a binding agent are mixed at a mass ratio of 90:5:5 and dispersed into N-methylpyrrolidone to prepare a slurry, and the slurry is applied on an aluminum foil as a collector for a positive electrode, dried and then punched out in the form of a disk having a diameter of 12.5 mm to make a positive electrode. On the other hand, as a negative electrode is used a lithium metal sheet having a diameter of 12.5 mm and a thickness of 1.0 mm. Then, the positive and negative electrodes are overlapped through a separator (micro-porous film: made of polypropylene) impregnated with the electrolyte, and accommodated in a stainless case serving as a positive terminal, and sealed with a stainless sealing plate serving as a negative terminal through a polypropylene gasket to prepare a coin-type battery (lithium secondary battery) having a diameter of 20 mm and a thickness of 1.6 mm.

(3) Discharge-Recharge Test for the Coin-Type Battery (Initial Discharge Capacity and Load Characteristics)

With respect to the thus obtained coin-type battery, discharge-recharge are repeated in an atmosphere of 20° C. at a voltage range of 4.2-3.0 V and a current density of 0.2 mA/cm² two cycles, and the discharge capacity measured at this time is divided by a known mass of the positive electrode to determine the initial discharge capacity (mAh/g). Then, the current density is changed to 2.0 mA/cm², the discharge-recharge are further repeated two cycles, and the load characteristics (%) is calculated from an average value of the discharge capacity by using the following equation:

Load characteristics(%)=(the average value of the discharge capacity at a current density of 2.0 mA/cm²)/(the average value of the discharge capacity at a current density of 0.2 mA/cm²)×100.

Results are shown in Table 2.

### Example 5

A non-aqueous electrolyte is prepared by dissolving LiPF₆ at a concentration of 1 mol/L in a mixed solvent comprising 50% by volume of ethyl difluorophosphate, 25% by volume of ethylene carbonate and 25% by volume of methyl ethyl carbonate and further adding 3% by mass of 4-fluorovinylene carbonate, and the electric conductivity and the flame retardance of the resulting non-aqueous electrolyte are evaluated in the same manner as in Example 4. Also, a lithium secondary battery is made in the same manner as in Example 4, and the initial discharge capacity and the load characteristics of the battery in the discharge-recharge test are measured and evaluated. Results are shown in Table 2.

### Example 6

A non-aqueous electrolyte is prepared by dissolving LiPF₆ at a concentration of 1 mol/L in a solvent of 100% by volume of propyl difluorophosphate and further adding 3% by mass of vinylene carbonate, and the electric conductivity and the flame retardance of the resulting non-aqueous electrolyte are evaluated in the same manner as in Example 4. Also, a lithium secondary battery is made in the same manner as in Example 4, and the initial discharge capacity and the load characteristics of the battery in the discharge-recharge test are measured and evaluated. Results are shown in Table 2.

### Comparative Example 3

A non-aqueous electrolyte is prepared by dissolving LiPF₆ at a concentration of 1 mol/L in a mixed solvent comprising 50% by volume of ethylene carbonate and 50% by volume of methyl ethyl carbonate, and the electric conductivity and the flame retardance of the resulting non-aqueous electrolyte are evaluated in the same manner as in Example 4. Also, a lithium secondary battery is made in the same manner as in Example 4, and the initial discharge capacity and the load characteristics of the battery in the discharge-recharge test are measured and evaluated. Results are shown in Table 2.

### Comparative Example 4

A non-aqueous electrolyte is prepared by dissolving LiPF₆ at a concentration of 1 mol/L in a mixed solvent comprising 20% by volume of trimethyl phosphate, 40% by volume of ethylene carbonate and 40% by volume of ethyl methyl carbonate and further adding 3% by mass of vinylene carbonate, and the electric conductivity and the flame retardance of the resulting non-aqueous electrolyte are evaluated in the same manner as in Example 4. Also, a lithium secondary battery is made in the same manner as in Example 4, and the initial discharge capacity and the load characteristics of the battery in the discharge-recharge test are measured and evaluated. Results are shown in Table 2.

### Comparative Example 5

A non-aqueous electrolyte is prepared by dissolving LiPF₆ at a concentration of 1 mol/L in a mixed solvent comprising 50% by volume of triethyl phosphate, 25% by volume of ethylene carbonate and 25% by volume of ethyl methyl carbonate and further adding 3% by mass of vinylene carbonate, and the electric conductivity and the flame retardance of the resulting non-aqueous electrolyte are evaluated in the same manner as in Example 4. Also, a lithium secondary battery is made in the same manner as in Example 4, and the initial discharge capacity and the load characteristics of the battery in the discharge-recharge test are measured and evaluated. Results are shown in Table 2.

TABLE 2

| | | | Initial | Load |
|---|---|---|---|---|
| | Electric | | discharge | charac- |
| | conductivity | Evaluation of | capacity | teristics |
| | (mS/cm) | flame retardance | (mAh/g) | (%) |
| Example 4 | 10.2 | Flame retardance | 139 | 93 |
| Example 5 | 14.2 | Non-combustibility | 140 | 98 |
| Example 6 | 12.8 | Non-combustibility | 138 | 97 |
| Comparative | 8.5 | Combustion property | 140 | 81 |
| Example 3 | | | | |
| Comparative | 6.2 | Self-extinguishing | 118 | 48 |
| Example 4 | | property | | |
| Comparative | 5.0 | Flame retardance | 58 | 32 |
| Example 5 | | | | |

As seen from Examples 4-6 in Table 2, the non-aqueous electrolyte containing the compound of the formula (I) or the compounds of the formulae (I) and (II) has the flame retardance or non-combustibility and the high electric conductivity, and also the battery using the same is excellent in the load characteristics. Thus, it is confirmed that the non-aqueous electrolyte for the battery according to the invention has the high flame retardance and electric conductivity and the non-aqueous electrolyte secondary battery having excellent safety and load characteristics can be obtained by using the non-aqueous electrolyte in the non-aqueous electrolyte secondary battery.

On the other hand, as seen from Comparative Examples 4 and 5 in Table 2, the non-aqueous electrolyte added with the usual phosphate triester is improved in the flame retardance as the additive amount is increased, but its electric conductivity is lowered and the initial discharge capacity and the load characteristics of the battery are deteriorated by the reductive decomposition of the phosphate triester.

Based on the above results, there can be provided the non-aqueous electrolyte secondary battery balancing the high flame retardance and the battery performances by using the non-aqueous electrolyte characterized by containing the fluorophosphate compound represented by the general formula (I).

1. A non-aqueous electrolyte for a battery comprising a non-aqueous solvent and a support salt, characterized in that the non-aqueous electrolyte for the battery further contains a
fluorophosphate compound represented by the following general formula (I): 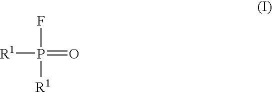
wherein R¹s are independently fluorine, an alkoxy group or an aryloxy group and at least one of two R¹s is the alkoxy group or the aryloxy group, provided that two R¹s may be bonded with each other to form a ring.

2. A non-aqueous electrolyte for a battery according to claim 1, wherein one of two R¹s is fluorine and the other is the alkoxy group or the aryloxy group in the general formula (I).

3. A non-aqueous electrolyte for a battery according to claim 1, wherein at least one of two R¹s is a fluorine atom-substituted alkoxy group or a fluorine atom-substituted aryloxy group in the general formula (I).

4. A non-aqueous electrolyte for a battery according to claim 3, wherein one of two R¹s is fluorine and the other is the fluorine atom-substituted alkoxy group or the fluorine atom-substituted aryloxy group in the general formula (I).

5. A non-aqueous electrolyte for a battery according to claim 1, which further contains an unsaturated cyclic ester compound represented by the following general formula (II): 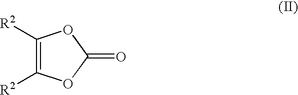
wherein R²s are independently hydrogen, fluorine or an alkyl group having a carbon number of 1-2.

6. A non-aqueous electrolyte for a battery according to claim 5, wherein a content of the unsaturated cyclic ester compound represented by the general formula (II) is 0.1-10% by mass based on the whole of the non-aqueous electrolyte.

7. A non-aqueous electrolyte for a battery according to claim 1, wherein the non-aqueous solvent comprises an aprotic organic solvent.

8. A non-aqueous electrolyte for a battery according to claim 1, wherein a content of the fluorophosphate compound represented by the general formula (I) is not less than 5% by volume based on the whole of the non-aqueous electrolyte for the battery.

9. A. non-aqueous electrolyte for a battery according to claim 8, wherein the content of the fluorophosphate compound represented by the general formula (I) is not less than 10% by volume based on the whole of the non-aqueous electrolyte for the battery.

10. A non-aqueous electrolyte for a battery according to claim 9, wherein the content of the fluorophosphate compound represented by the general formula (I) is not less than 20% by volume based on the whole of the non-aqueous electrolyte for the battery.

11. A non-aqueous electrolyte secondary battery comprising a non-aqueous electrolyte for a battery as claimed in claim 1, a positive electrode and a negative electrode.

12. A. non-aqueous electrolyte secondary battery according to claim 11, wherein lithium or an, alloy thereof is used in the negative electrode.
